(19) United States
(12) Patent Application Publication
(10) Pub. No.: US 2026/0107070 A1
(43) Pub. Date: Apr. 16, 2026

(54) CAMERA SYSTEM AND IMAGE PROCESSING METHOD THEREOF

(71) Applicant: HIMAX TECHNOLOGIES LIMITED, Tainan City (TW)

(72) Inventors: Po Chang CHEN, Tainan City (TW); Wei Chieh YANG, Tainan City (TW)

(21) Appl. No.: 18/918,036

(22) Filed: Oct. 16, 2024

(51) Int. Cl. H04N 23/84; H04N 19/136; H04N 19/85; H04N 25/51

(52) U.S. Cl. CPC H04N 23/843; H04N 19/136; H04N 19/85; H04N 25/51

(57) ABSTRACT

A camera system includes a camera and a user's device. The camera includes an image sensor and an image pre-processor. The image sensor generates a raw image, and the image pre-processor consists essentially of a tone mapping circuit, a demosaic circuit, and a color space conversion circuit. The tone mapping circuit converts a raw gray level value corresponding to each pixel in the raw image into a target gray level value. The target gray level value is zero when the raw gray level value is less than or equal to a black level value. The demosaic circuit converts the raw image with the target gray level value into a format of RGB data, and the color space conversion circuit converts the format of RGB data into a format of YUV data. The user's device includes an image post-processor to perform post-processes on a compressed image received from the camera.

### BACKGROUND

### Technical Field

The disclosure relates to a camera system and an image processing method thereof, and more particularly to a camera system with low power consumption and an image processing method thereof.

### Description of Related Art

In a camera, an image sensor and an image processor roughly dominate overall system power consumption. The conventional image processor performs image processes such as color correction matrix (CCM), auto-white balance (AWB), defect pixel correction (DPC), denoise, sharpening, black level subtraction (BLS), data range extension, lens shading correction, and demosaic, etc., for improving image quality. However, performing too much image processes may result in high system power consumption as well as reduction of battery life.

### SUMMARY

An objective of the present disclosure is to provide a camera system which includes a camera. The camera includes an image sensor and an image pre-processor. The image sensor is configured to generate a raw image and includes pixels. The image pre-processor is electrically connected to the image sensor and consists essentially of a tone mapping circuit, a demosaic circuit, and a color space conversion circuit. The tone mapping circuit is configured to convert a raw gray level value corresponding to each of the pixels in the raw image into a target gray level value, among them, the target gray level value is zero when the raw gray level value is less than or equal to a black level value. The demosaic circuit is configured to convert the raw image with the target gray level value into a format of RGB data. The color space conversion circuit is configured to convert the format of RGB data into a format of YUV data.

Another objective of the present disclosure is to provide an image processing method adapted to a camera system. The image processing method includes performing pre-processes. Performing the pre-processes consists essentially of generating a raw image by pixels of an image sensor in a camera of the camera system; converting a raw gray level value corresponding to each of the pixels in the raw image into a target gray level value, among them, the target gray level value is zero when the raw gray level value is less than or equal to a black level value; converting the raw image with the target gray level value into a format of RGB data; and converting the format of RGB data into a format of YUV data.

Yet another objective of the present disclosure is to provide a camera system which includes a camera. The camera includes an image sensor and an image pre-processor. The image sensor includes pixels and a tone mapping circuit. The tone mapping circuit is configured to convert a raw gray level value corresponding to each of the pixels in a raw image into a target gray level value, among them, the target gray level value is zero when the raw gray level value is less than or equal to a black level value. The image pre-processor is electrically connected to the image sensor and consists essentially of a demosaic circuit and a color space conversion circuit. The demosaic circuit is configured to convert the raw image with the target gray level value into a format of RGB data. The color space conversion circuit is configured to convert the format of RGB data into a format of YUV data.

### BRIEF DESCRIPTION OF THE DRAWINGS

FIG. 1 is a schematic diagram showing a camera system in accordance with an embodiment of the present disclosure.

FIG. 2 is a schematic diagram showing the camera system and an internal structure of a user's device in accordance with an embodiment of the present disclosure.

FIG. 3 is a schematic diagram showing a tone mapping curve in accordance with an embodiment of the present disclosure.

FIG. 4 is a schematic diagram showing a camera system in accordance with an embodiment of the present disclosure.

FIG. 5 is a schematic diagram showing an image processing method in accordance with an embodiment of the present disclosure.

FIG. 6 is a flow diagram showing an operational flow of a camera in accordance with an embodiment of the present disclosure.

FIG. 7 is a flow diagram showing an operational flow of a capturing mode in accordance with an embodiment of the present disclosure.

FIG. 8 is a flow diagram showing an operational flow of an application (APP) of the user' device in accordance with an embodiment of the present disclosure.

### DETAILED DESCRIPTION

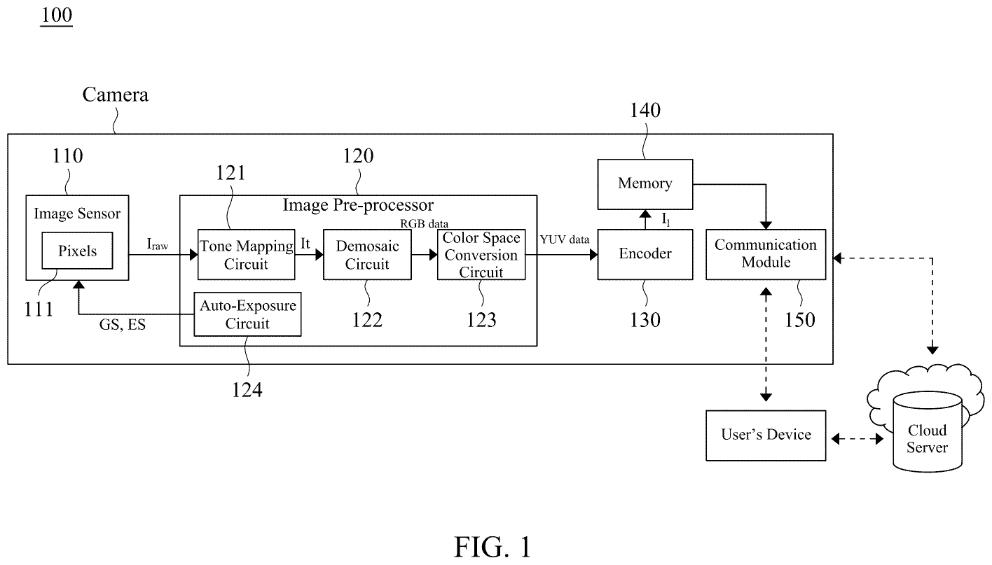

Referring to FIG. 1, FIG. 1 is a camera system 100 in accordance with an embodiment of the present disclosure. The camera system 100 includes a camera, a cloud server, and a user's device. The camera includes an image sensor 110 and an image pre-processor 120. The image sensor 110 includes pixels 111 that are arranged in a matrix for converting light signals into electrical signals to generate a raw image I_{raw}. The image sensor 110 may be, for example, a charge-coupled device (CCD) image sensor, a complimentary metal-oxide semiconductor (CMOS) image sensor, or the like. The image pre-processor 120 is electrically connected to the image sensor 110 and consists essentially of a tone mapping circuit 121, a demosaic circuit 122, and a color space conversion circuit 123.

The image pre-processor 120 only performs image pre-processes such as tone mapping, demosaicing (or named color interpolation), and color space conversion on the raw image I_{raw} for minimizing power consumption of the camera. By retaining the chosen image pre-processes, not only the image quality can be maintained within a certain level, but the power consumption of the camera can also be significantly reduced. Specifically, image compression may cause image distortion, so it is necessary to do pre-processing before image compression to reduce image distortion. The invention retains tone mapping, demosaicing, and color space conversion processes as the most economical pre-processes, so that the image quality can still within the certain level after compression, e.g., blocky artifacts and contour artifacts of the image may be reduced and the image details may be preserved as much as possible.

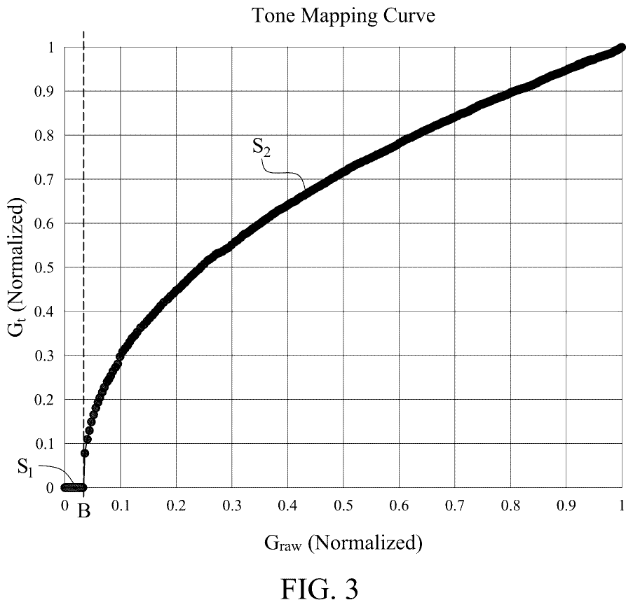

The tone mapping circuit 121 is configured to convert a raw gray level value G_{raw} corresponding to each pixel 111 in the raw image I_{raw} into a target gray level value Gₜ. A relationship between the raw gray level value G_{raw} and the target gray level value Gₜ is expressed as a tone mapping curve shown in FIG. 3. The horizontal axis represents the normalized raw gray level value G_{raw} and the vertical axis represents the normalized target gray level value Gₜ.

In the first section S₁, the raw gray level value G_{raw} is less than or equal to the black level value B, and the target gray level value Gₜ is zero. In the second section S₂, the raw gray level value G_{raw} is greater than the black level value B, and the target gray level value Gₜ can be determined corresponding to the raw gray level value G_{raw} of the pixels 111. In some embodiments, the tone mapping curve is expressed as a tone mapping lookup table which includes values corresponding to target gray level values and raw gray level values for determining the target gray level value Gₜ.

Specifically, the tone mapping circuit 121 performs image processes including black level subtraction (BLS), data range extension (DRE), and gamma correction on the raw gray level value G_{raw} of the raw image I_{raw}. These image processes reflect the relationship between the target gray level value Gₜ and the raw gray level value G_{raw}, which is represented as the tone mapping curve. Through the tone mapping curve, the raw gray level value G_{raw} corresponding to each pixel 111 can be quickly calibrated to the target gray level value Gₜ, thereby completing the aforementioned image processes (BLS, DRE, and gamma correction).

The demosaic circuit 122 is configured to convert the raw image I_{raw} with the target gray level value Gₜ (marked as Iₜ in FIG. 1) into a format of RGB data. The demosaic circuit 122 may apply algorithms such as bilinear interpolation, nearest neighbor interpolation, adaptive color plane interpolation, directional interpolation, high-order interpolation, deep learning, or the like on the raw image I_{raw} with the target gray level value Gₜ to obtain the format of RGB data.

The color space conversion circuit 123 converts the format of RGB data into a format of YUV data for reducing data size and improving compression efficiency. The format of the YUV data may be YUV444, YUV422, YUV420, or other common formats, but the disclosure is not limited thereto.

The image pre-processor 120 further consists of an auto-exposure circuit 124. The auto-exposure circuit 124 is configured to provide a gain control signal GS and an exposure control signal ES to control an exposure of the image sensor 110. The gain control signal GS and the exposure control signal ES are used to automatically adjust settings of the image sensor 110 to achieve the correct exposure for the raw image I_{raw}. The raw image I_{raw} outputted to the image pre-processor 120 can be ensured with proper image brightness for image pre-processing and for human viewing application.

In some embodiments, the camera further includes an encoder 130, a memory 140, and a communication module 150. The encoder 130 is configured to compress and encode the raw image I_{raw} with the target gray level value Gₜ in the format of YUV data into a first image I₁. The memory 140 is configured to store the first image I₁. The communication module 150 is configured to transmit the first image I₁ stored in the memory 140 to the cloud server or the user's device. With the encoder 130 compressing the data size, the communication module 150 can transmit the first image I₁ to a cloud server or a user's device more efficiently.

The cloud server is configured to store the first image I₁ transmitted from the communication module 150. Specifically, the memory 140 may store one or more first images I₁ received from the camera, and the communication module 150 will be triggered to transmit the first images I₁ to the cloud server for storage when a storage space of the memory 140 is full.

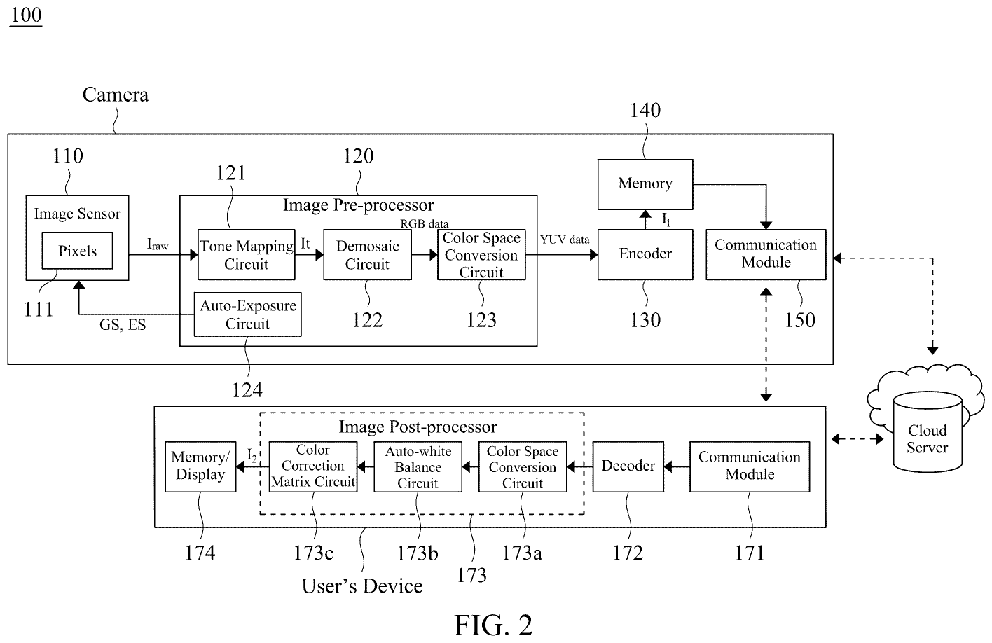

The user's device is electrically connected to the cloud server and the camera. As shown in FIG. 2, the user's device includes a communication module 171, a decoder 172, an image post-processor 173, and a display 174 (or a memory). The communication module 171 is configured to communicate with the camera or the cloud server. A user can download the first image I₁ stored in the cloud server or directly receive the first image I₁ stored in the memory 140 through wireless communication between communication modules 150 and 171. The decoder 172 is configured to decompress and decode the first image I₁ received from the memory 140 or the cloud server.

The image post-processor 173 is configured to perform post-processes on the first image I₁ for converting the first image I₁ into a second image I₂. The image post-processor 173 includes a color space conversion circuit 173a, an auto-white balance circuit 173b, and a color correction matrix circuit 173c. The color space conversion circuit 173a is configured to convert the first image I₁ of YUV data into RGB data. The auto-white balance circuit 173b is configured to perform an auto-white balance process on the first image I₁(RGB data). The color correction matrix circuit 173c is configured to perform a color correction process on the first image I₁(RGB data). After performing the image post-processes such as auto-white balance, color correction, or other common image processing processes, the image post-processor 173 may produce the second image I₂ that is color-corrected and proper for human viewing. In some embodiments, the image post-processor 173 is configured to perform post-processes by the software program.

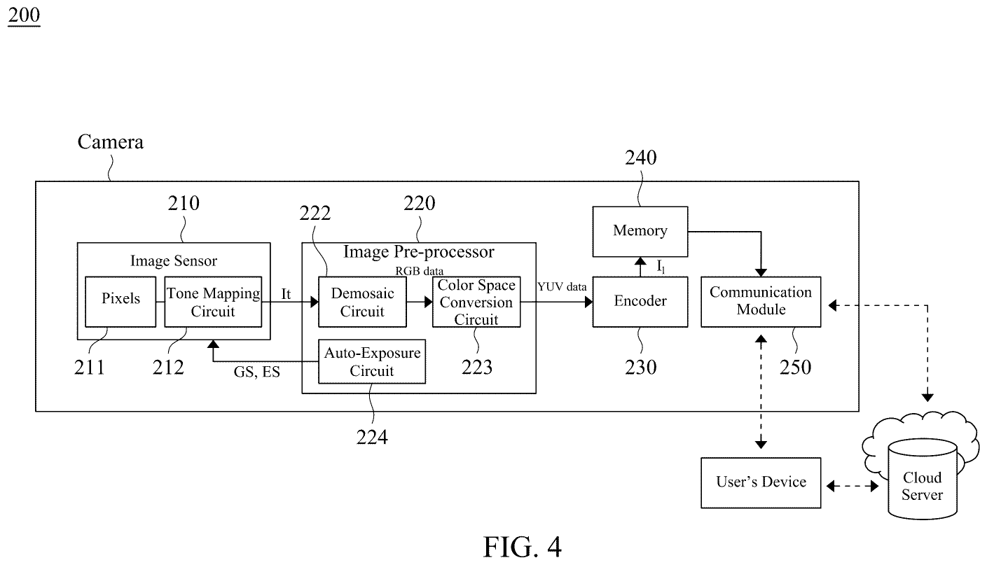

Referring to FIG. 4, FIG. 4 is a camera system 200 in accordance with an embodiment of the present disclosure. The camera system 200 includes a camera, a cloud server, and a user's device. The camera includes an image sensor 210 and an image pre-processor 220. The difference between the camera system 200 (shown in FIG. 4) and the camera system 100 (shown in FIG. 1) is that the tone mapping circuit 212 is embedded in the image sensor 210 instead of the image pre-processor 220. In such embodiment, the tone mapping circuit 212 converts the raw gray level value G_{raw} corresponding to each pixel 111 into the target gray level value Gₜ in the image sensor 210 for outputting the raw image I_{raw} with the target gray level value Gₜ to the image pre-processor 220. The target gray level value Gₜ also can be determined by referring to the tone mapping lookup curve shown in FIG. 3.

Other functions and structures (such as the internal structure of the user's device shown in FIG. 2) of the camera system 200 are similar to those described in camera system 100, and thus are not repeated herein.

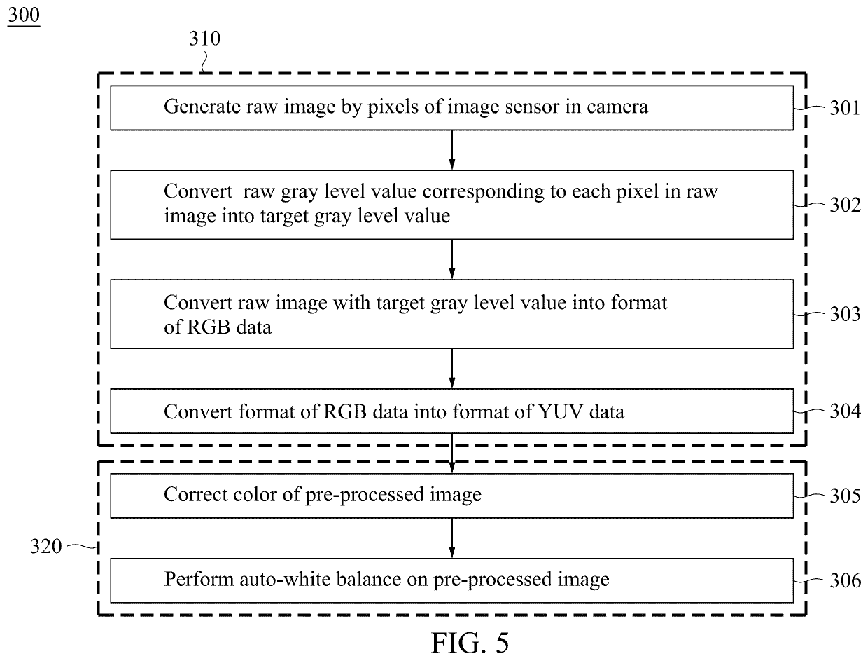

Referring to FIG. 5, FIG. 5 is a schematic diagram showing an image processing method 300 in accordance with an embodiment of the present disclosure. The image processing method 300 includes performing pre-processes 310 in a camera and performing post-processes 320 in a user's device. Performing the pre-processes 310 consists essentially of Steps 301 to 304, and performing the post-processes 320 includes Steps 305 to 306, and these steps may be applied to the configuration shown in FIGS. 1, 4 or another similar configuration. The configuration shown in FIG. 1 is taken as an example for the following description.

At Step 301, the image sensor 110 generates the raw image I_{raw} by the pixels 111 of the image sensor 110. The image sensor 110 may capture several raw images I_{raw} and output these raw images I_{raw} to the image pre-processor 120 for performing tone mapping, demosaicing (or referred to as color interpolation), and color space conversion processes.

At Step 302, after receiving the raw image I_{raw} form the image sensor 110, the tone mapping circuit 121 converts the raw gray level value G_{raw} corresponding to the pixels 111 in the raw image I_{raw} into the target gray level value Gₜ. The target gray level value Gₜ of each pixel 111 can be obtained by referring to the tone mapping curve (or tone mapping lookup table) shown in FIG. 3. As shown in FIG. 3, the target gray level value Gₜ is zero when the raw gray level value G_{raw} is less than or equal to the black level value B, and the target gray level value Gₜ corresponding to the raw gray level value G_{raw} can be found in the second section S₂ when the raw gray level value G_{raw} is greater than the black level value B.

At Step 303, after the raw gray level value G_{raw} is converted into the target gray level value Gₜ, the demosaic circuit 122 converts the raw image I_{raw} with the target gray level value Gₜ into the format of RGB data.

At Step 304, after the raw image I_{raw} is converted with the target gray level value Gₜ into the format of RGB data, the color space conversion circuit 123 converts the format of RGB data into the format of YUV data.

In some embodiments, step 302 further includes correcting the raw gray level value G_{raw} by a gamma correction value γ to obtain the target gray level value Gₜ. In some embodiments, the gamma correction value γ is between 1.8 and 2.2. By referring to the tone mapping lookup curve shown in FIG. 3, the tone mapping circuit 121 may manipulate the gray levels of the pixels 111 in various bit lengths, for example, 0-255 in 8 bits, 0-1023 in 10 bits, or 0-65535 in 16 bits.

BLS process, DRE process, and gamma correction process are integrated into the tone mapping curve (or the tone mapping lookup table) shown in FIG. 3. The tone mapping circuit 121 only needs to refer the tone mapping curve for determining the target gray level value Gₜ, the pre-processes 310 applied on the raw image I_{raw} are completed.

In some embodiments, performing the pre-processes 310 further consists of providing the gain control signal GS and the exposure control signal ES by the auto-exposure circuit 124 to control the exposure of the image sensor 110.

In some embodiments, after performing the pre-processes 310, the image processing method 300 further consists of compressing and encoding the raw image I_{raw} with the target gray level value Gₜ in the format of YUV data into a first image I₁.

In some embodiments, after compressing and encoding the raw image I_{raw} with the target gray level value Gₜ in the format of YUV data, the image processing method 300 further consists of transmitting the first image I₁ to the cloud server or the user's device.

After performing the pre-processes 310 in the camera, the post-processes 320 may be performed on the user's device. At Steps 305 and 306, color correction and auto-white balance processes may be performed on the pre-processed image to generate the second image I₂ on the user's device that is viewable by the user. In embodiments that the camera includes performing compressing and encoding processes, the image processing method 300 further includes performing a decoding process (not shown) on the pre-processed image before performing the post-processes 320.

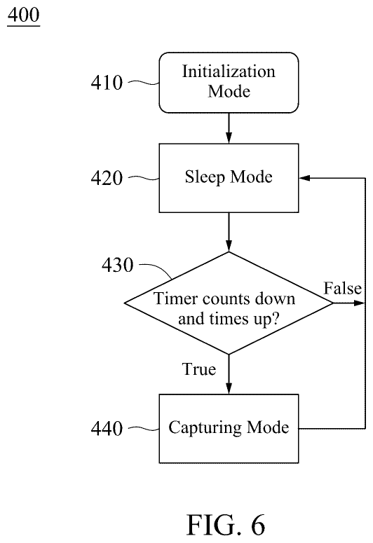

Referring to FIG. 6, FIG. 6 is a flow diagram showing an operational flow 400 of camera in accordance with an embodiment of the present disclosure. The operational flow 400 of camera includes Steps 410 to 440.

At Step 410, the camera is in an initialization mode, which includes setting up a pre-defined timer parameter for controlling the period of frame capturing, that is equivalent to frame rate control.

At Steps 420, the camera is in a sleep mode, which means the camera stays in standby or event monitoring state and only wakes up when triggered by the timer for image capturing. Under the sleep mode, the communication module 150 also only wakes up when the memory 140 is full for transmitting all captured images stored in the memory 140. Therefore, the camera system 100 may stay in sleep mode in most of the time and consumes very less power.

At Step 430, the timer counts down and determines whether the time is up. When the time is not up, the camera keeps in the sleep mode. When the time is up, the camera ends the sleep mode and enters the capturing mode.

At Step 440, the camera is in a capturing mode to capture and process images in a very low frame rate, e.g., one snapshot per min. Under the sleep mode, the communication module 150 is mostly off unless the memory 140 is full, and it will be triggered to transmit all the images stored in the memory 140 to the cloud server and then re-enters the sleep mode.

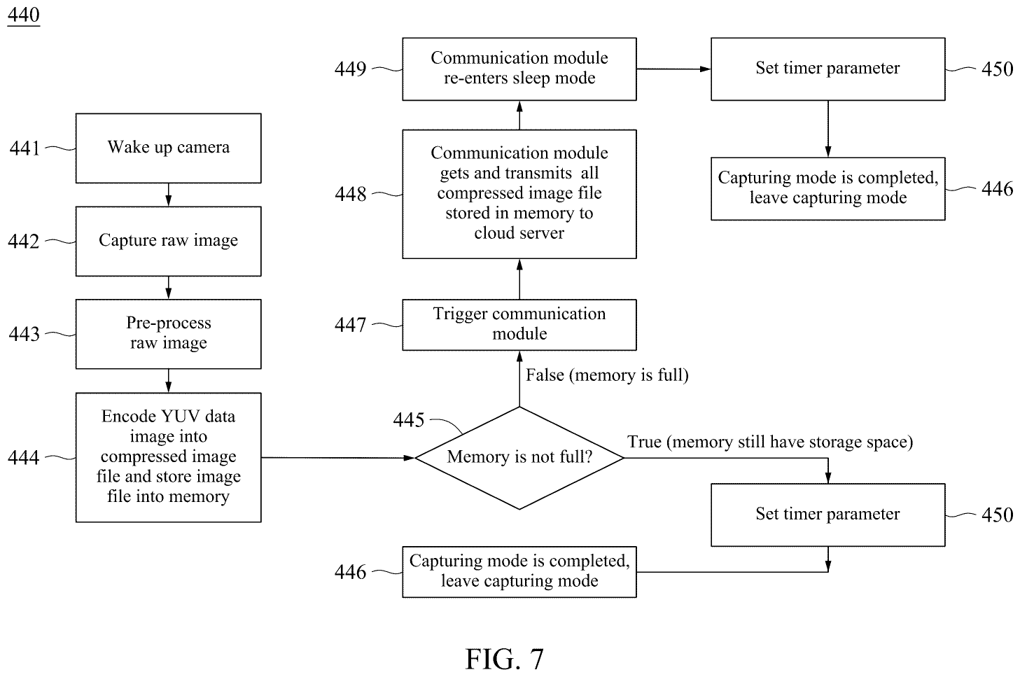

Referring to FIG. 7, FIG. 7 is a flow diagram showing an operational flow of the capturing mode (Step 440) in accordance with an embodiment of the present disclosure. The operational flow of the capturing mode includes Steps 441 to 450.

At Step 441, the camera is woken up. At Step 442, the image sensor 110 captures a raw image I_{raw} first. At Step 443, the image pre-processor 120 pre-processes the raw frame I_{raw} with tone mapping, demosaic, color space conversion to generate the raw image I_{raw} with the target gray level value Gₜ in the format of YUV data. At Step 444, the encoder 130 encodes the raw image I_{raw} with the target gray level value Gₜ in the format of YUV data into a compressed image file (the first image I₁), and then the compressed image file is stored into the memory 140.

At Step 445, the camera determines whether the storage space of the memory 140 is full. When the storage space of the memory 140 is full, Step 447 is performed to trigger the communication module 150. When the storage space of the memory is not full, at Step 450 the image pre-processor 120 sets the timer parameter. Step 446 is performed to end the capturing mode.

At Step 447 and Step 448, the communication module 150 is triggered to get and transmit all the compressed image files stored in the memory 140 to the cloud server. At Step 449, the communication module 150 completed transmission of all the compressed image files and re-enters the sleep mode. At Step 450, the image pre-processor 120 sets the timer parameter again. After setting the timer parameter, the capturing mode ends (Step 446).

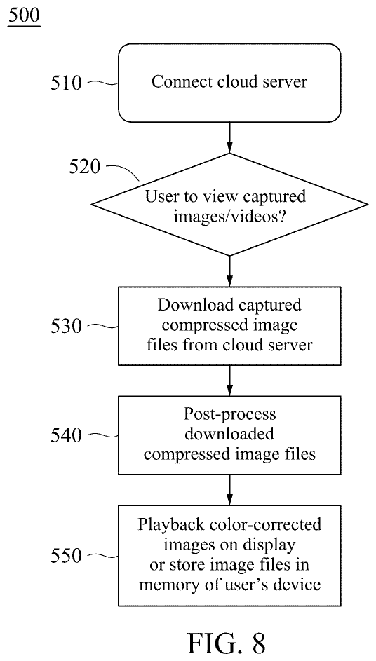

Referring to FIG. 8, FIG. 8 is a flow diagram showing an operational flow 500 of the application (APP) of the user' device in accordance with an embodiment of the present disclosure. The operational flow 500 of the APP of user' device includes Steps 510 to 550.

At Step 510, the APP of the user' device is in initialization state and electrically connects the cloud server. At Step 520, the image post-processor 173 determines whether a user wants to view the captured images/videos. When the user wants to view the captured images/videos, Step 530 is performed to download the captured compressed image file (the first image I₁) from the cloud server.

At Step 540, the image post-processor 173 post-processes the downloaded compressed image files by auto-white balance process, color correction process, or the like to produce color-corrected images (the second image I₂). The color-corrected images may be the format of YUV data or RGB data (depend on whether the color space conversion circuit is included between the image post-processor 173 and the display 174). At Step 550, the color-corrected images (the second image I₂) are played back on the display 174 or stored in the memory of the user's device.

The disclosure provides a camera system and an image processing method thereof to achieve lower power consumption while the image quality is kept acceptable to human eyes by reserving essential image pre-processes in the image pre-processor of the camera and performing other image post-processes (such as auto-white balance and color correction processes) in the image post-processor of the use's device or cloud server. The essential image pre-processes consists essentially of tone mapping, demosaicing, and color space conversion, and the tone mapping only includes BLS, DRE, and gamma correction processes, which not only effectively reduces power consumption, but also increases the battery life.

Although the description provided above is of various embodiments of the disclosure, this should not limit the scope of the disclosure. Those with ordinary skill in the art can make various modifications without departing from the spirit and scope of the disclosure. Therefore, the scope of protection of the present disclosure shall be determined by the following claims.

What is claimed is:

1. A camera system, comprising:
a camera, comprising:
an image sensor configured to generate a raw image, wherein the image sensor comprises a plurality of pixels; and
an image pre-processor electrically connected to the image sensor, wherein the image processor consisting essentially of:
a tone mapping circuit configured to convert a raw gray level value corresponding to each of the plurality of pixels in the raw image into a target gray level value, wherein the target gray level value is zero when the raw gray level value is less than or equal to a black level value;
a demosaic circuit configured to convert the raw image with the target gray level value into a format of RGB data; and
a color space conversion circuit configured to convert the format of RGB data into a format of YUV data.

2. The camera system of claim 1, wherein the tone mapping circuit is configured to determine the target gray level value corresponding to the raw gray level value by referring to a tone mapping lookup table in a condition in which the raw gray level value is greater than the black level value.

3. The camera system of claim 2, wherein the tone mapping circuit is further configured to correct the raw gray level value by a gamma correction value to obtain the target gray level value.

4. The camera system of claim 1, wherein the image pre-processor further consists of:
an auto-exposure circuit configured to provide a gain control signal and an exposure control signal to control an exposure of the image sensor.

5. The camera system of claim 1, wherein the camera further comprising:
an encoder configured to compress and encode the raw image with the target gray level value in the format of YUV data to obtain a first image.

6. The camera system of claim 5, wherein the camera further comprising:
a memory configured to store the first image; and
a communication module configured to transmit the first image to a cloud server or a user's device.

7. The camera system of claim 6, wherein the cloud server configured to store the first image while a storage space of the memory is full.

8. The camera system of claim 5, further comprising:
a user's device electrically connected to the camera and comprising:
an image post-processor configured to convert the first image into a second image, the image post-processor further comprises:
an auto-white balance circuit configured to perform an auto-white balance process on the first image; and
a color correction matrix circuit configured to perform a color correction process on the first image to obtain the second image.

9. The camera system of claim 8, wherein the user's device further comprising:
a decoder configured to decompress and decode the first image.

10. An image processing method adapted to a camera system, comprising:
performing pre-processes, consisting essentially of:
generating a raw image by a plurality of pixels of an image sensor in a camera of the camera system;
converting a raw gray level value corresponding to each of the plurality of pixels in the raw image into a target gray level value, wherein the target gray level value is zero when the raw gray level value is less than or equal to a black level value;
converting the raw image with the target gray level value into a format of RGB data; and
converting the format of RGB data into a format of YUV data.

11. The image processing method of claim 10, wherein converting the raw gray level value corresponding to each of the plurality of pixels into the target gray level value comprises:
determining the target gray level value corresponding to the raw gray level value by referring to a tone mapping lookup table in a condition in which the raw gray level value is greater than the black level value.

12. The image processing method of claim 11, wherein converting the raw gray level value corresponding to each of the plurality of pixels into the target gray level value further comprises:
correcting the raw gray level value by a gamma correction value to obtain the target gray level value.

13. The image processing method of claim 10, wherein performing the pre-processes further consisting of:
providing a gain control signal and an exposure control signal by an auto-exposure circuit to control an exposure of the image sensor.

14. The image processing method of claim 10, further consisting of:
compressing and encoding the raw image with the target gray level value in the format of YUV data to obtain a first image.

15. The image processing method of claim 14, further comprising:
decoding the first image; and
after decoding the first image, performing post-processes, comprising:
correcting a color of the first image; and
performing an auto-white balance on the first image.

16. A camera system, comprising:
a camera, comprising:
an image sensor, comprising:
a plurality of pixels; and
a tone mapping circuit configured to convert a raw gray level value corresponding to each of the plurality of pixels in a raw image into a target gray level value, wherein the target gray level value is zero when the raw gray level value is less than or equal to a black level value; and
an image pre-processor electrically connected to the image sensor, wherein the image pre-processor consisting essentially of:
a demosaic circuit configured to convert the raw image with the target gray level value into a format of RGB data; and
a color space conversion circuit configured to convert the format of RGB data into a format of YUV data.

17. The camera system of claim 16, wherein the tone mapping circuit is configured to determine the target gray level value corresponding to the raw gray level value by referring to a tone mapping lookup table in a condition in which the raw gray level value is greater than the black level value.

18. The camera system of claim 17, wherein the tone mapping circuit is further configured to:
correct the raw gray level value by a gamma correction value to obtain the target gray level value.

19. The camera system of claim 16, wherein the camera further comprising:
an encoder configured to compress and encode the raw image with the target gray level value in the format of YUV data to obtain a first image.

20. The camera system of claim 19, further comprising:
a user's device electrically connected to the camera and comprising:
a decoder configured to decode the first image; and
an image post-processor configured to convert the first image into a second image, the image post-processor further comprises:
an auto-white balance circuit configured to perform an auto-white balance process on the first image; and
a color correction matrix circuit configure to perform a color correction process on the first image to obtain the second image.
